(19) United States
(12) Patent Application Publication
(10) Pub. No.: US 2007/0078729 A1
(43) Pub. Date: Apr. 5, 2007

(54) Itinerary planning tool, system, method, software, and hardware

(76) Inventor: Kevin Lee Brown, Springfield, VA (US)

Correspondence Address: MAXVALUEIP CONSULTING, 11204 ALBERMYRTLE ROAD, POTOMAC, MD, 20854, US

(21) Appl. No.: 11/557,397

(22) Filed: Nov. 7, 2006

Related U.S. Application Data
(63) Continuation-in-part of application No. 11/080,254, filed on Mar. 14, 2005.
(60) Provisional application No. 60/843,617, filed on Sep. 11, 2006.

(51) Int. Cl. G06Q 30/00

(52) U.S. Cl. 705/26

(57) ABSTRACT

An activity-based itinerary planning tool permits a trip planner to incrementally build an itinerary, starting at a selected entry point and adding activities in a step-by-step manner, by taking into account commute times for different types of transportation and entry/exit conditions for particular activities/facilities, in order to present the user with lists of all activities/facilities that can be reached from the entry point or from already-selected activities/facilities. Also, an electronic marketplace for consumers and suppliers of activities to meet and exchange. Consumers are given search tools for narrowing all possible activities to those a consumer can actually perform and attend, based on their proximity and performance criteria. Suppliers are given tools to enter activities into a central repository, and set constraints to prevent unqualified consumers from purchasing. Detection change monitors the activities of the database for changes that will invalidate original recommendations, and provides consumer notification.

### CROSS REFERENCE TO THE RELATED APPLICATIONS

This application is related to the U.S. Provisional Patent Application Ser. No. 60/843,617, filed on Sep. 11, 2006, with the same inventor and assignee, incorporated herein by reference.

This application is a continuation-in-part of the U.S. patent application Ser. No. 11/080,254, entitled “Itinerary Planning Tool, System, and Method”, filed on Mar. 14, 2005, with the same inventor and assignee, incorporated herein by reference, including its IDS.

This application is also related to the U.S. Provisional Patent Application Ser. No. 60/556,777, entitled “Systematic Budgeted Itinerary Planning and Validation”, filed on Mar. 28, 2004, with the same inventor and assignee, also incorporated herein by reference.

### FIELD OF THE INVENTION

The present invention relates to a software package for enabling an electronic marketplace for consumers and suppliers of activities to meet and exchange. More specifically, the present invention is a software package for enabling an electronic marketplace within an itinerary planning tool that permits a consumer to select activities offered by a supplier, and incrementally create an itinerary, by manipulating a plurality of variables, by finding suppliers via a multi-user network, such as the Internet.

### BACKGROUND OF THE INVENTION

The current methods for a consumer to discover an activity are inefficient for a number of reasons. For example, one can collect and sort through numerous publications in an effort to find a desired activity, but that may require extensive internet search, the purchase of books, and a large investment of time. Recently, Internet search engines are being used as research tools that often return an overwhelming amount of data. When using an Internet search engine, the collection of data seems to become less of an issue than determining which activities are relevant to a consumer's requirements.

Consumers and suppliers must have a meeting of the minds in order for the activity to take place. Since the majority of activities are meant to be performed by the consumer, there is a need for the consumer to be able to arrive on time, have the physical or emotional ability to perform the activity, and to meet the supplier's criteria.

The supplier is given a tool to enter his activity into a central repository. The supplier sets constraints to prevent unqualified consumers from purchasing. This tool saves a lot of time for the consumer and also focuses the supplier's offering to the right consumers.

There are a number of systems that allow a consumer to search activities known in the prior art. Once such website is WhatsONWhen. When using this system, a consumer enters the category, country, and a time window. Unfortunately, the results are too broad to use in the planning of a vacation. Typically a consumer must continue to perform additional research to determine if the desired activity is close to their accommodations, if transportation is available, and if it meets his ability.

The website CitySearch includes an added feature showing how close an activity is to a city center, but offers no way to enter a time window. Here, deficiencies are related to time. For example, it is impossible to attend past events that shown and returned in the results, and consumers are unable to search for future events that may correspond to an upcoming vacation period.

In the prior art, there exist systems that match a traveler with a service or business, based on their proximity and specific preferences. For example, U.S. Pat. No. 7,071,842 also commonly known as “Earthcomber” uses a GPS device, carried by a traveler, to determine the location, and software calculates proximity distance. Business advertisements are presented to a traveler based on services requested in their preferences. This does not work for activities requiring planning and reservations, such as golfing. It is not reasonable to assume a consumer will travel a foreign destination with golf clubs hoping for an alert that a course is nearby. Typically, such travel requires pre-vacation planning at home, by searching for the best-rated golf courses and making a reservation, weeks in advance to guarantee availability, while on vacation.

U.S. Pat. No. 5,930,699 discloses a proximity search that is based on current location with respect to a cellular network. It suffers from the shortcomings that one must perform the search at visited location, must know in advance the types of point-of-interest (POI), to make a request, and makes no allowance for reaching the POI during operating hours, such as commute time by car. For example, a consumer would not be able to match a remotely-located beach (with no address or nearby landmark) to a vacation activity of swimming. The commuting time from the consumer's accommodation to the activity would not be available from the request or inquiry.

Also, in the prior art, there are some systems that try to match a consumer and a supplier in a marketplace. For example, U.S. Pat. No. 7,054,880 provides an example of the consumer and supplier providing data about a commodity transaction they wish to make. It has no remedies for activities where the consumer must be present to take advantage of the purchase, and no validation is made to see if the consumer can physically be there to attend the activity.

U.S. Pat. No. 7,071,842 requires a distance and preferences match to alert a consumer about the supplier. Distance is not a suitable metric for detailed vacation planning because other factors such as transportation and travel time must be considered. This prior art system fails to alert consumers on impossible-to-attend activities, by neglecting commuting times, transportation options, and required time windows.

For Microsoft Streets and Trips 2006, the application does not assemble itinerary based on activities, and one does not know the activities at the point of interest (POI).

For Yahoo Trip Planner Beta, the planning does not account for limited accessibility operating hours.

For MSN Travel Beta, it provides information from Frommer's about travel destination, and thus, cannot change the itinerary based on the updates and changes for the event schedule and location (concert schedule, for example).

There is also a list of references which were mentioned in the IDSs that accompanied the parent/co-pending case, U.S. Ser. No. 11/080,254, entitled “Itinerary Planning Tool, System, and Method”, filed on Mar. 14, 2005. Those also apply to the current application, incorporated by reference.

In fact, numerous travel planning products are currently available to assist in making reservations for transportation, lodging, meals, and events, and to provide travel directions. These conventional “itinerary planning” products, which include popular websites accessible under the names Expedia, Orbitz, PriceLine and Hotwire, can be used to build crude itineraries that encompass airline flights, vehicle rentals, lodgings, meals, and selected events, but leave it up to the user to ensure that scheduled activities do not overlap, and that there is sufficient time to get to the facilities that provide the lodgings, meals, and events. This can be a time-consuming and error-prone process, especially if the user is unfamiliar with the area in which the activities are to take place.

In fact, all the prior art are crude itinerary planners, with very limited scope, and they do not do a real itinerary planning in a real sense, shifting the burden on the user to figure things out or plan manually. In fact, they are only shopping carts of the activities and travel products, with no consideration of contradictions or constraints, in terms of time or distance.

The problem, in essence, is that most currently available itinerary planning products permit the user to select events or facilities without verifying whether it is possible to reach the facilities, and thus, have the disadvantage of either permitting the user to make reservations for events that cannot be reached within the time allotted, or to spend time researching and calculating travel times. The most popular of these products, Expedia, Orbitz, PriceLine and Hotwire, all enable the user to make airline reservations, rent a car, rent accommodations, and make advance ticket purchases, without regard to any conflicts between scheduled activities.

If the user plans to rent a vehicle, the user can turn to “route planning” products such as Rand McNally TripMaker Deluxe 2004, which provide detailed directions and travel times between selected locations. The information obtained from these products can then be used to look-up lodging, meals, and other activities, available at the trip destination. However, it is still up to the user to prevent conflicts between activities based on the route information. The “route planning” software does not automatically narrow down potential activities in order to ensure that there is no conflict.

As a result, even with the assistance of “route planning” software, building an “itinerary” using conventional travel planning products is, in practice, an unwieldy process that requires multiple information sources and/or repeated visits to different websites. Planning a trip to an unfamiliar location using currently-available trip planning tools can takes hours, and often ends up being no more efficient than simply using a guidebook and telephone.

What is needed is a way to apply the incremental itinerary planning paradigm of a guidebook, in which all activities are available in a single source, with the advantages of automated calculation of commute times between activities, storage of results, and real time verification of facility availability or making the reservations. To date, none of the available travel planning products or tools permits incrementally building of a detailed step-by-step itinerary that not only lists activities, but also takes into account transportation times, and therefore, precludes invalid itineraries. Even where simple route planning tools are integrated with or hyperlinked to websites that offer lodging and car rental reservations, the user often must:
determine from websites that provide lists of activities what activities are available at what times,
if traveling by a vehicle rented at the destination, turn to route planning software to determine which activities can be reached in available times,
return to the activity listing websites to cross-check arrival time against hours of operation, verify actual availability, and narrow the list of activities,
return to route planning software to select different routes as necessary,
and similar tasks to verify availability and compatibility between events and activities.

This process, which is already difficult and time-consuming, is greatly complicated, if the area is question is a popular destination, and only a few time slots are available for each activity, or if other modes of transportation are to be taken into account, such as island-hopping flights, ferries, trains, urban mass transportation, bicycles, and foot travel. Most “route planning” programs assume car travel only, while the travel websites offer only limited alternative modes of transportation, and offer information on activities reachable by car only, without considering the possibility of using the alternative modes of transportation to expand the range of possible activities available at a particular destination.

Use of “itinerary” creating software (note that the definition of itinerary in prior art is very limited, as explained above, with very limited functionality, shifting most of the burden to the user to figure things out manually), such as Expedia or the like, does have the significant advantage of ensuring the availability of facilities, but only if the trip planner already knows where he or she is going to, and only needs to match the closest available flight times and dates. On the other hand, use of route planning software (such as the Rand McNally TripMaker Deluxe 2004) has the advantage of permitting the user to calculate the quickest/shortest routes, providing directions between waypoints, and providing the ability to choose sites of interest along the planned route, based on the distance from route, but only if the trip planner is traveling by automobile. Both types of trip planning products fail to validate arrival time and stop-over duration against facility hours of operation. Neither takes into account, in a convenient and integrated manner, the possibility of using multiple modes of transportation, other than vehicles, and adjustment of an itinerary, to include side trips by boat or plane (rather than just by car), nor it automatically selects a mode of transportation that will enable the facility to be reached in the allotted time.

It should be understood that the term “itinerary” as used herein refers to creation of an individualized itinerary, as opposed to a pre-packaged itinerary in which lodging, meals, theater tickets, event passes, and so forth are sold as a “package,” and only limited departures from the predetermined itinerary are possible. Many commercial websites that purport to facilitate “itinerary planning” actually simply present a list of pre-packaged itineraries, with little possibility of departure from a pre-selected schedule of time slots for visiting a limited selection of restaurants, lodgings, and attractions.

Aside from the above-reference commercially-available products, several prior patents disclose what are described as route planning tools or software. These include:
U.S. Pat. No. 5,559,707, which describes a system that lists points of interest within a predetermined radius of a selected destination, but does not calculate travel times, permit selection of modes of transportation, or permit building an itinerary by listing facilities reachable within a selected time from a point of entry or previously selected facility.
U.S. Pat. Nos. 5,940,803 and 6,119,095, which describe itinerary planners that enable building of an itinerary by selecting places to visit, calculating the commute time to the place, and choosing a time to stay at each location, but they do not preclude the planner from choosing facilities or locations that cannot be arrived at recommended visiting time or within allowable margins, and they have the further disadvantage of failing to provide lists of available activities (from which to choose).

With respect to the latter patents, the commercial websites at least have the advantage of highlighting certain activities available in a particular area. The itinerary planners disclosed in U.S. Pat. Nos. 5,940,803 and 6,119,095 force the user to input desired locations and activities before presenting a list of facilities. If the user is unfamiliar with a particular destination region, then the user may not choose the most interesting activities available, preventing the user from taking full advantage of the experiences available at the chosen travel destination. The only current solution is to turn to a secondary source of information, such as a guidebook or website with information on the destination, which makes it more complicated. In addition, in case of a guidebook, the information may be outdated very fast, especially for changes in time and location of an event, such as a concert.

Finally, none of the itinerary planning tools discussed above even considers more mundane processes of entering and exiting an activity, such as packing and checking out of a hotel, parking, and waiting in line to enter and exit a crowded event or attraction. If the activity is rental of an item, consideration must be given to the time it takes to check the rented item out and to return the item, as well as to acquire any external resources necessary to engage in the activity, such as transport to the rental facility. For example, a kayak trip without a rental stand near the entry point will require renting a kayak and transporting it, as well as final returning it to the rental agency, all of which need to be considered for time spent, when checking for conflicts between activities based on “commute” times between the activities for a chosen mode of transportation.

### SUMMARY OF THE INVENTION

The present invention provides a unique workflow to narrow all possible activities to those a consumer can actually perform with respect to their location and time window. Consumers of vacation products would especially appreciate the process of the present invention. For example, a consumer planning a vacation is normally unfamiliar with the specifics of the destination and often unclear with respect to the proximity relationship between accommodations and desired activities. To properly plan a vacation itinerary, available transportation, commuting times, and road hazards must be taken into account. This is solved by the recommendation engine of the present invention. Based on a consumer's departure location, commute dynamics, and time window of execution, a set of activities is pulled from all activities in the system by the recommendation engine.

It determines if the consumer is suited for the activity. For example, a consumer with disabilities will be sensitive to disability-friendly activities, while a family would stay clear of adult-only activities. More research is usually required from such sources, as recommendations, contacting the supplier, and travel books. This is, however, solved by the Performance engine. Based on the consumer's desires, needs, constraints, and composition, a set of activities are pulled for all activities in the system, to narrow down and focus his/her choices.

In the present invention, suppliers are given the tools to enter their activities into a central repository. The supplier sets constraints to prevent unqualified consumers from purchasing. The invention relieves the supplier of the burden of finding consumers of the product.

If the supplier changes the location and time of a recommended concert, a notification would be sent because the new data would have failed in the proximity engine, making a past recommendation invalid.

The objectives and advantages of the present invention focus on proximity searches of activities, based on commute times, not the distance between locations, thereby taking into account transportation and commuting limitations.

It is accordingly a first objective of the invention to teach a system that provides a marketplace for consumers and suppliers that enables searching for desired activities, with the ability to alert consumers on impossible-to-attend activities, by considering commuting times, transportation options, and required time windows. The consumer is presented only with the possible choices which can actually be practiced (and/or commuted to the location) in the amount of time allowed. (All available non-conflicting activities are presented, so that the user can take full advantage of the offerings presented by a chosen destination or region, without having to guess at what is available, or refer to a secondary source of information in order to input all desired activities or places to visit at the beginning of planning.) It also displays a list of all activities that it is possible to take part in, within or at selected time periods, and that ensures that all intended activities will be in accordance with entry and exit conditions, i.e., that sufficient time is available to carry out the activities, taking into account transportation times between activities for a selected mode of transportation. It takes into account multiple transportation options for reaching available facilities, rather than just automobiles, allowing the user to reach places unattainable by car, travel faster to reach more distant locations, including those separated by water, and take advantage of numerous public systems available in an urban environment, such as bus or bicycle. It also validates processes of going from one activity to another, including entering and exiting an activity, and enforce accountability for mundane activities, like the time needed to check out of accommodations and returning the rental car.

It is a second objective of the present invention to teach a self-sufficient electronic marketplace where search engines are used to take the burden of discovery off the consumer, and place it on a computer system. Both the consumer and the supplier are only required to enter qualifying data. Notifications are sent out to all parties interested in computer search's results.

It is a third objective of the present invention to teach a system that qualifies whether a consumer can reach the location in a timely manner, and if the requirements of the suppler are validated. This includes (but is not limited to) the operating hours and reservation requirements of a supplier that insures that the activity is available, once the traveler has arrived.

It is a fourth objective of the present invention to teach a planning aid for an activity. Considering changes in the activity information invalidates previous recommendations, and they are reported automatically to all concerned parties. This warns a consumer to take action and rework their plans.

Finally, due to the overwhelming number of activities, search engines are available to the consumer to tailor a subset of all possible activities. Itineraries are built iteratively from selected entry points.

For example, if the selected starting point is the airport, the itinerary planning tool of the invention will provide the user with a list of all activities that can be reached from the airport, within a given time and time slots, when the activities are available, excluding those that cannot be reached, and taking into account entry/exit conditions, as well as travel times, thereby permitting the user to select the activity and/or a facility in which the activity is to take place with minimal likelihood of conflict under normal conditions (excluding weather, unusual traffic, unscheduled closures, or other circumstances that might cause a conflict to occur). The “activity” might be having lunch, checking into a place of lodging, visiting a museum, kayaking, or taking a shuttle to another island. Once the user has selected the activity and time, the itinerary planning tool will present the user with another list of available “activities,” “facilities,” and so forth, until the itinerary is completed.

Users appreciate that the itinerary planning tool of the invention is “activity-based” rather than “location-based.” Furthermore, the itinerary planning tool of the invention preferably permits the selection of “subsets” of an activity, which takes into account the concept of “divisibility.” The most general “activity” will have a start time, a duration, a supplier, an action to perform, and its divisibility property/divisible components. However, not all activities are divisible. For example, a snorkel trip by boat is indivisible. One cannot start the activity late since the boat will have already left, and one cannot end the activity early because the boat is still under way. The itinerary planner of the invention takes into account the fact that the activity must be attended in whole, based on divisible property, and declares the activity unattendable, if a previous or subsequent activity, including travel times and entry/exit conditions, does not permit the activity to be attended as a whole.

In one embodiment, the software considers margin of error for the time, for traffic, unexpected weather, or extra cushion-time for unexpected events, so that the events can be calculated and suggested based on a margin, assigned by the user, or by the software, based on the past/history of the events/delays in prior years or months, for example. A conventional neural network can be used here for the training of the module, based on the prior (history) results, parameters, delays, events, and/or margins.

According to one embodiment, activity hours of operation are retrieved from a database, and the user refines the selection by providing a “time window” defined by the start time and the amount of time or duration (that the user would like to stay at the location). This time window intersects the activities, breaking them up into subsets. The possible activity attendances are limited to subsets contained within the time window and are available for selection, while indivisible activities that are intersected are represented as missed activities and are unavailable for selection. The planner can continue to change the time window, until he/she gets satisfied with the amount of time spent on the activity. Thus, some time intervals are fixed and some are flexible, and the software would give optimum result to the user.

To summarize, it should be understood that the term “activity” as used herein is not limited to a particular type of activity, and that it may encompass checking in, checking out, or spending time at a place of lodging, acquiring, returning, using a rental item, eating a meal, visiting an attraction such as a museum or monument, taking a tour, attending a show or event, climbing a mountain, or any other item that needs to be, or that is susceptible of being, scheduled in advance, in order to ensure that there will be time for the activity. On the other hand, the term “facility” refers to the location where the activity takes place, or in the case of an activity that does not take place at a single location, to the entry and exit points for the activity, while the term “commute” refers to travel between facilities, irrespective of mode of transportation. It is one of the advantages of the invention that the itinerary can take into account a variety of modes of transportation, including multiple modes of transportation in a single commute, either automatically selected based on time, distance, and availability, or selectable in-whole or in-part by the itinerary planner.

### BRIEF DESCRIPTION OF THE DRAWINGS

FIG. 1 is a schematic diagram of an itinerary planning system than includes an itinerary planning tool constructed in accordance with the principles of an embodiment of the invention, including external components needed to carry out operations.

FIG. 2 is a data flow diagram showing the interaction of highest level components, used in building an itinerary according to the principles of the invention.

FIG. 3 is a data flow diagram showing interaction of components used in selecting the activities at the first visited location in the itinerary.

FIG. 4 is a data flow diagram showing the process of adding a selected activity to the itinerary.

FIG. 5 is a data flow diagram showing the process of calculating possible activities given an allotted amount of time.

FIG. 6 is a data flow diagram showing the process of calculating possible destinations, given a single mode of transportation.

FIG. 7 is a data flow diagram showing the process of calculating possible destinations given the flexibility to choose multiple modes of transportation.

FIGS. 8-10 are “screen shots” showing examples of display screens for allowing a user to input selections of possible activities.

FIG. 11 is a dataflow diagram illustrating the highest level interaction with the users of the present invention.

FIG. 12 is a dataflow diagram showing the interaction of components used to supply the recommendation engine with input, and assemble the results into an intelligible form.

FIG. 13 is a screen shot of the GUI of the present invention illustrating a location map and input means for a consumer to search for activities based on commute time, activity time, audience, and transportation mode, with respect to commute or location.

FIG. 14 is a screen shot of the GUI of the present invention illustrating a list of activities that can be performed.

FIGS. 15 is a screen shot of the GUI of the present invention illustrating means for suppliers to enter pertinent information about their establishment into the system.

FIG. 16 is a screen shot of the GUI of the present invention illustrating means for supplier to enter offered activity information into the system.

FIG. 17 is a screen shot of the GUI of the present invention illustrating means for supplier to manage all activities they own in the system.

FIGS. 18-19 show the relationship between different entities in different settings/markets.

FIGS. 20-29 show various snapshots from screens/interfaces for the user at different stages interacting with the system, indicating various possibilities, features, ease-of-use, and value of the system.

### DEFINITION OF THE TERMS

By “activities” is meant any action to perform that has a start time, a duration, and a supplier. This includes not only events, tours, amusements, and the like, but also meals, lodging, car rentals, and other trip items that need to be scheduled, together with incidents of activities, such as rental of equipment, waiting in line, parking, and so forth. The invention makes no distinction between an activity and a task. One usually associates an activity with fun things to do, but here it could be viewed as job tasks in a business application, as well. The invention could be used by a service company to enter work order tasks for employees. The consumer, an employee of the service company on the road, could search for tasks that were suited for his current situation.

For example, a salesman for a drug company can locate and schedule visiting nearby hospitals and clinics, efficiently, in non-rush hour periods, and filling up the rest of the time/gaps with the meal/food activities or any fun/tourist activities, within the reach of time and distance, between the important business appointments. Thus, some activities are crucial and cannot be sacrificed (such as business meetings), and others are optional, and can be omitted (such as fun activities), with respect to the others.

In a corporate environment, the multi-user planner can be used, using the input from salesman's manager, dictating the important meetings, not to be missed. Any telephone conference can be done from any location, as long as the time allocated is sufficient.

The user may have multiple preferences, or set of choices, each with a weight of importance assigned to it, with 100 percent meaning having the highest priority. The software assigns or determines multiple solutions, and orders them, based on these weights or collective weights.

It should be understood that the term “itinerary” as used herein refers to creation of an individualized itinerary, as opposed to a pre-packaged itinerary in which lodging, meals, theater tickets, event passes, and so forth are sold as a “package,” and only limited departures from the predetermined itinerary are possible. Many commercial websites that purport to facilitate “itinerary planning” actually simply present a list of pre-packaged itineraries, with little possibility of departure from a pre-selected schedule of time slots for visiting a limited selection of restaurants, lodgings, and attractions.

On the other hand, the term “facility” refers to the location where the activity takes place, or in the case of an activity that does not take place at single location, to the entry and exit points for the activity, while the term “commute” refers to travel between facilities, irrespective of mode of transportation. It is one of the advantages of the invention that the itinerary can take into account a variety of modes of transportation, including multiple modes of transportation in a single commute, either automatically selected based on time, distance, and availability, or selectable in-whole or in-part by the itinerary planner.

### DETAILED DESCRIPTION OF THE PREFERRED EMBODIMENTS

This invention relates to software for planning itineraries, hereinafter referred to an “itinerary planning tool.” The tool permits a user to select activities and incrementally create an itinerary by:
selecting an entry point;
retrieving data concerning all activities accessible from the entry point, and available start times and durations;
calculating whether available start times and durations intersect a time window determined by arrival at the entry point and a departure date, and commuting time between the entry point and the facility where the activity is to take place or begin (based on a selected or automatically chosen mode of transportation), in order to exclude activities, generating a list of possible activities;
displaying a the list of possible activities, together with any available related information, such as sponsor information; and
upon selection by the user of an activity, adding the activity to an Itinerary. In addition, the itinerary planning tool enables adding to an itinerary by:
retrieving data concerning all activities accessible from a previously selected activity, and available start times and durations;
calculating whether available start times and durations intersect a time window determined by that, which takes into account a commute time between activities, and using the calculation to exclude activities from a second list of potential activities;
displaying the second list of possible activities;
upon selection of an activity from the second list of possible activities, continuing to retrieve data on available activities and display lists, until the Itinerary is completed, or system resources are exceeded.

In a preferred embodiment of the invention, the itinerary planning tool is implemented in the form of a website or .html pages, stored on a server and downloaded upon request, via a web browser to a computer or other computing device. Alternatively, the itinerary planning tool may be provided in the form of a software package installed at the user's end, or on a mobile device, such as phone or PDA. In either case, the itinerary planning tool is arranged to access one or more databases containing information on activities, including locations, times of availability and, optionally, sponsor information or advertisements, supplied by local merchants, chain stores, tourist organizations, federal, state or local agencies, or local chamber of commerce. The database(s) may be local, i.e., stored on the server that contains the planning device, or may be accessed remotely.

Alternatively, they may be stored, or updated for any new information, on stick memory devices, mobile memory devices, magnetic media, optical media, via satellite, provisioning, synchronization, download from a web site, using patch, upgrades/updates, routine periodic updates, or any other method of information update or transfer, available for a fee, free, or based on subscription, provided by same/original company, a third party, or individual users, as feedback, rating system, or evaluation of facilities or activities.

The point system of feedback by users can be a good advice for future users/consumers, and can police/coordinate the way the providers improve their offerings, according to the desire and taste of the users.

Unlike conventional trip planning tools available over the Internet, the trip planning tool calculates travel or “commute” times between facilities where activities are to take place, based on a selectable, or automatically chosen mode of transportation, and excludes facilities that cannot be reached during times that the activity is available, thereby precluding invalid itineraries.

The trip planning tool is part of a system and method that enables Internet users to prepare activity-based itineraries in a simple and intuitive manner, by selecting from among a variety of activities and modes of transportation, while automatically taking into account time and distance.

The following figures show only one embodiment/example, and are not limiting the scope of claims or invention:

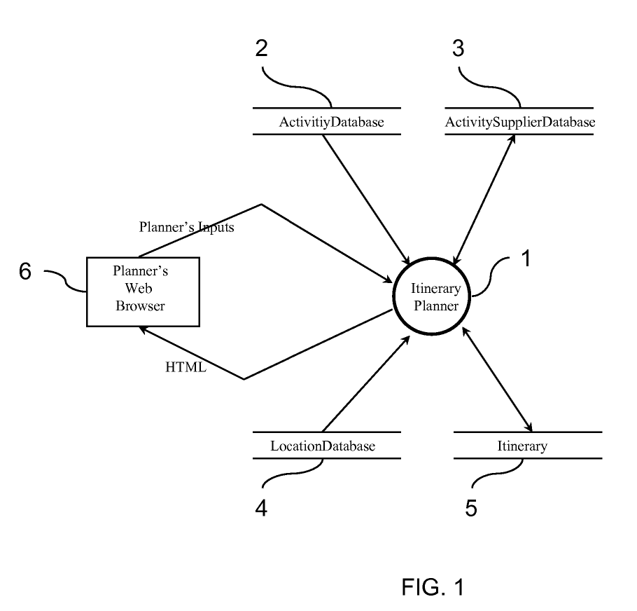

FIG. 1 is a schematic diagram of an itinerary planning tool and system, constructed in accordance with an embodiment of the invention. The itinerary planning tool 1 is preferably offered over the Internet and resides in one or more servers to which a “planner” or end-user of itinerary planning tool 1 may be connected with the assistance of a web browser 6 that resides on the planner's computer, local area network server, or computing device, such as a PDA or cellular telephone. The planning tool is further connected to various databases, which may be locally stored in the same facility as the planning tool, or distributed over a number of locations connected over the Internet, or via other communications lines or networks. One can implement the system in the form of “web pages” written in hypertext mark-up language, or a similar language, that is readable by the planner's browser and through which the user may interact with the itinerary planning tool, by inputting and receiving data in a well-known manner.

The databases, whose purpose will be described below, include an ActivityDatabase 2, an ActivitySuppliers Database 3, a LocationDatabase 4, and an ItineraryDatabase 5 for storing itineraries created by planners or users of the itinerary planning tool module. The ActivityDatabase stores descriptions of activities. The ActivitySuppliers Database supplies information about the party that is responsible for executing the activity. The LocationDatabase supplies information about facilities or locations that are associated with the activity. The end result of the itinerary planning shall be referred to herein as the “Itinerary.” It will, of course, be appreciated that any or all of the databases may be present in a single memory storage location, or distributed over multiple locations, and that the databases may be further divided into sub-databases, or include additional databases.

The planner provides inputs to the itinerary planning software, and/or to the system that includes the itinerary planning tool or software, through interaction with web browser 6. In addition, the itinerary planning tool requires data from the current Itinerary. In the case of a web-based itinerary planning tool, the tool sends HTML web pages back to the planner for additional input requests and display of incremental progress, in building the Itinerary. The Itinerary is the final product produced by the tool.

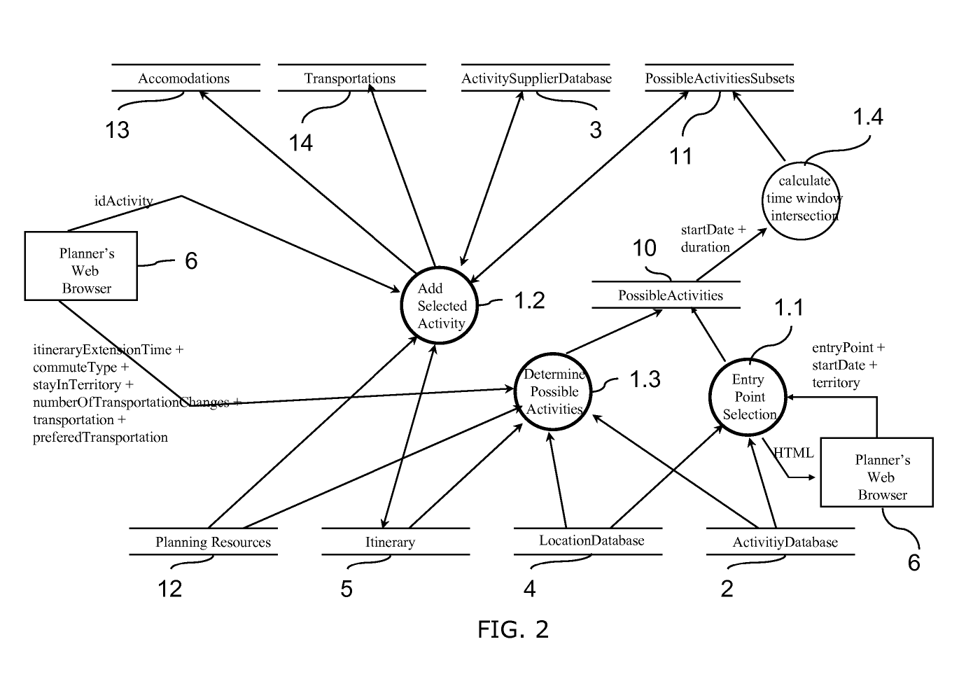

FIG. 2 shows the interaction of highest level components used in building the Itinerary. The planner starts the Itinerary by selecting from possible entry points into a territory (block 1.1). The entry points may include, but are not limited to, airports, ports, train, bus stations, other transportation hubs, or border crossings, depending on the particular characteristics of the territory and its relationship to the territory of the origin of the planner, or the location of another activity (for example, the planner might wish to begin planning an itinerary starting from the end of a convention or business meeting). So, this could be chain planning or hierarchical planning or itinerary, in general form. This can be applied to vacation, business meeting, or other purposes. Once the entry location is established, activities are retrieved from the ActivityDatabase 2 based on the selected entry location. The itinerary planning tool then determines (block 1.3) all activities 10 that it is possible to commute to within a given allotted time based on an itineraryExtensionTime input. Finally, the planner inputs the time to start and duration to spend on the activity, and subsets 11 of all the possible activities 10 are calculated (block 1.4), after which the planner adds an activity (block 1.2) from the calculated subset 11 of all possible activities to Itinerary 5. The process is repeated until he is finished adding new activities, or has exceeded PlanningResources limits 12.

It will be appreciated that the lists of possible activities can be modified according to pre-selected criteria, in addition to availability. By way of example, only, the planner may pre-select types of accommodations, meals, transportation options, and/or other activities based on cost, age, general preferences, and so forth, all of which can be taken into account in generating the possible activities 10 or subsets 11 thereof. Furthermore, once an activity is selected, the itinerary planner may contact, or enable the user to contact, the corresponding facility, such as an accommodation stored in an accommodation “inventory” or list 13, for reservations or tickets, as well as arranging for the commute between activities by a particular mode of transportation stored in an another “inventory” 14. In one embodiment, the telephone, e-mail, or other means of contact is provided. In addition, in one embodiment, there is a link to further information, pictures, FAQs, or user's feedback is also provided.

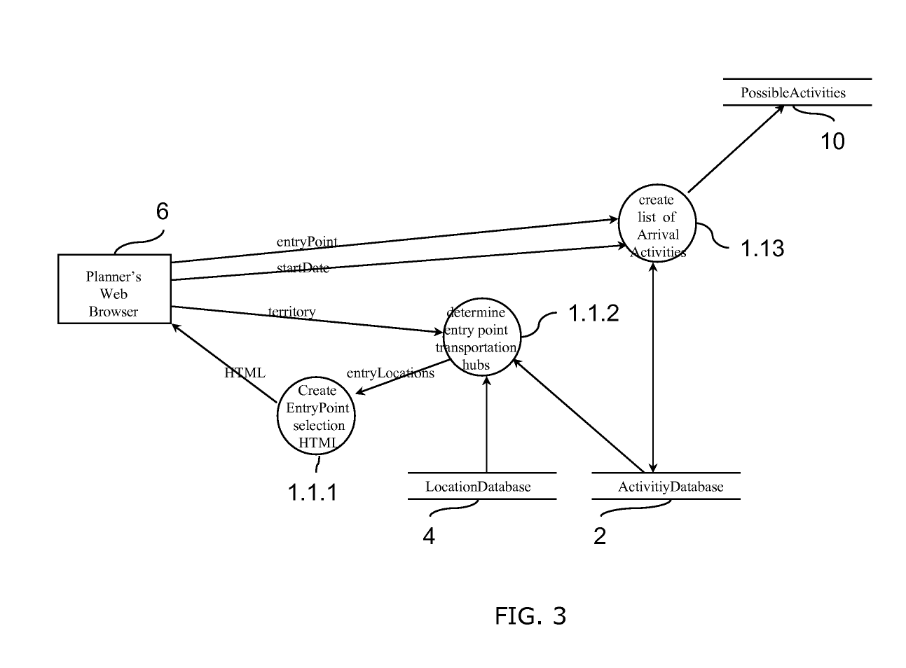

FIG. 3 illustrates the manner in which the Entry Point Selection block 1.1 of FIG. 2 uses the territory input by the planner, to retrieve from the ActivityDatabase 2 transportation activities that allow entering the territory (block 1.1.2). The locations of the activities are presented to the planner, as a limited set of locations that he may enter for territory. With the selected entryPoint and startDate provided by the planner through an entry point selection screen, displayed by the planning tool (block 1.1.1), the itinerary planning tool creates a list of available activities at the entryPoint (block 1.1.3) and deems them to be possible activities to start the Itinerary.

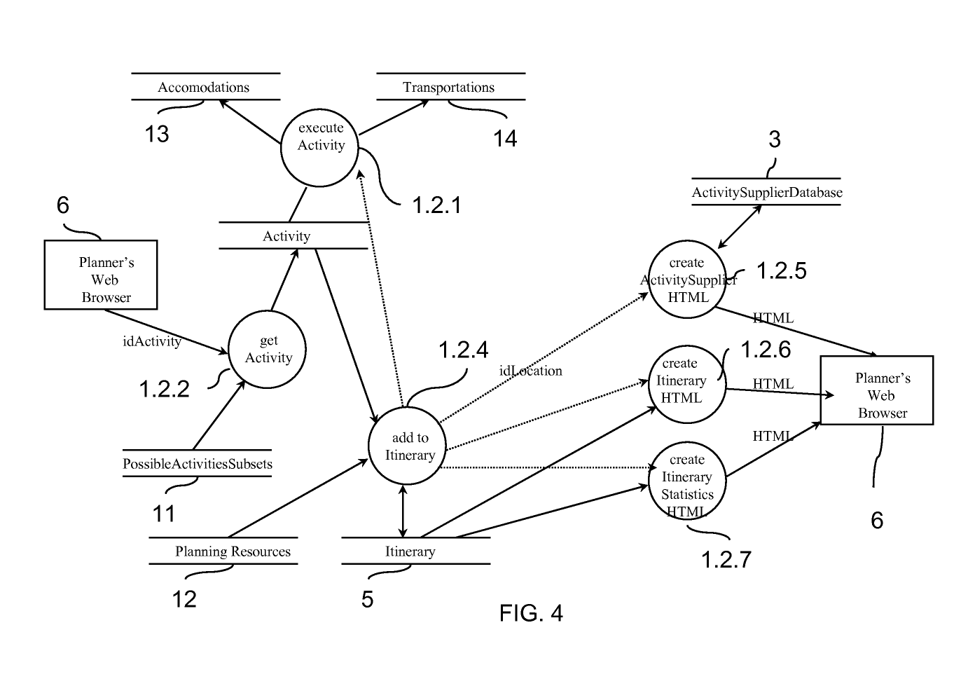

FIG. 4 shows how the preferred planning tool adds an activity selected by the planner to the Itinerary. Upon selection of the activity from the set 11 of all possible activities by, for example, inputting an identifier for the activity, “clicking” on the activity, or the like, the preferred itinerary planning tool retrieve associated data (step 1.2.2) and executes the activity as if the planner were on a trip to determine any side effects, and update inventories or running variables associated with Inventory entries or calculations.

“Side effects” are any effects of an activity that affect the availability of the planner to take part in another activity. Possible side effects include, but are not limited to, increases in expenditures, rental items being added to the inventory, or a change in location, if the activity happens to be a commute. Executing the activity represents a simulation of the planner at the activity. For example, for the activity of scuba diving, execution of the activity may represent a dive signature. If multiple dives occur during the trip, the planner could be prevented from reserving an airline flight before acceptable levels of nitrogen have left his or her blood stream, set by a specialist, user, or software.

The above-mentioned “inventories” are simply lists of items associated with activities in the Itinerary, and that must be updated as the Itinerary is developed. For example, if the activity is checking into an accommodation, the accommodation might be added to an accommodation inventory 13, so as to keep track of accommodation expenses, or alternatively to force a return to the accommodation before check-out. If the activity is renting a car, then it is added to the inventory or stored list of possible transportation 14 for later commutes, and it forces/reminds the return of the rental car, before flying back to “home.”

Both side effects and inventories may have an additional effect on planning resources, which are items such as costs that affect the activities that can be carried out. As shown in FIG. 4, whenever an activity is added, Planning Resources 12 are checked against current limits, for example, total budget limit. Only, if Planning Resources have not been exceeded, then the activity is appended to the Itinerary (step 1.2.4). Alternatively, a planner may choose not to keep track of planning resources, or the itinerary planning tool may simply keep a running total of expenses, and not provide any limit. The limit can be applied to time, food supply, and gas supply, as well.

Since the Itinerary has been changed internally in the itinerary planning tool, it now must be synchronized with the last Itinerary displayed to the planner, and the “location” of the planner get updated (block 1.2.3), for commute calculating purposes. Blocks 1.2.5, 1.2.6, and 1.2.6 (respectively) depict display by the itinerary planning tool for information concerning the responsible party or sponsor offering the activity, the most up-to-date version of the Itinerary, and the vital statistics about the Itinerary.

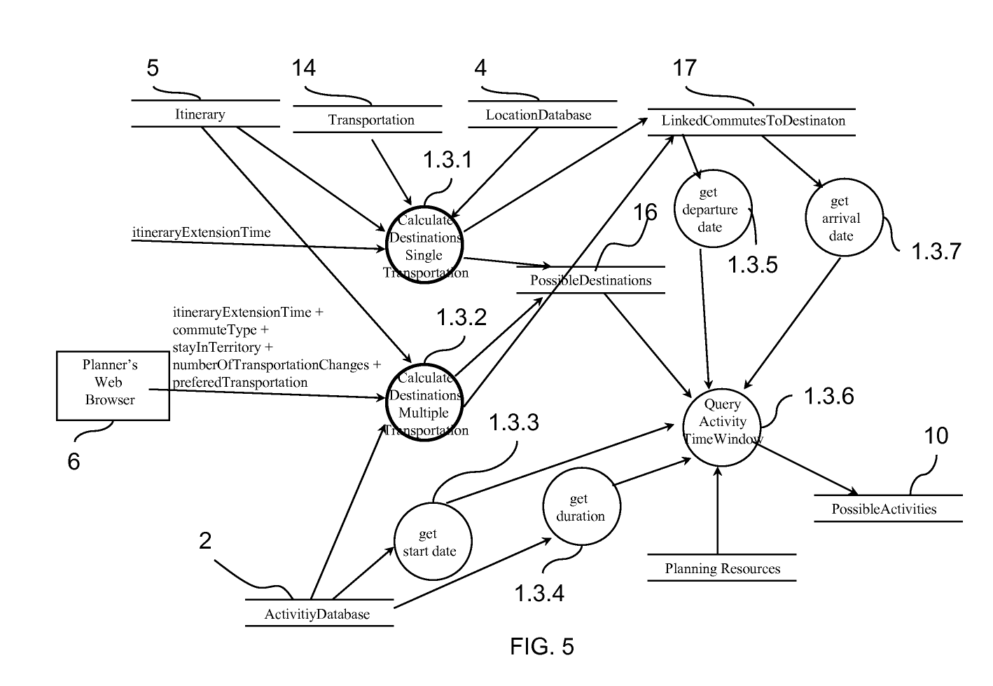

FIG. 5 shows a process for determining possible activities based on automatic selection of transportation modes. In the example of FIG. 5, the itinerary planning tool determines possible destinations 16 based either on a single mode of transportation (block 1.3. 1), or automatically selected multiple transportation modes (block 1.3.2), and determines what activities are possible at each destination by retrieving activities from the ActivityDatabase 2, based on their location and whether an activity's start and end date, depicted as being stored in LinkedCommutesToDestination 17, intersects or falls in the time window of the arrival and departure date of the commute to the destination (blocks 1.3.3 to 1.3.7). All activities that pass the query are declared possible activities 10.

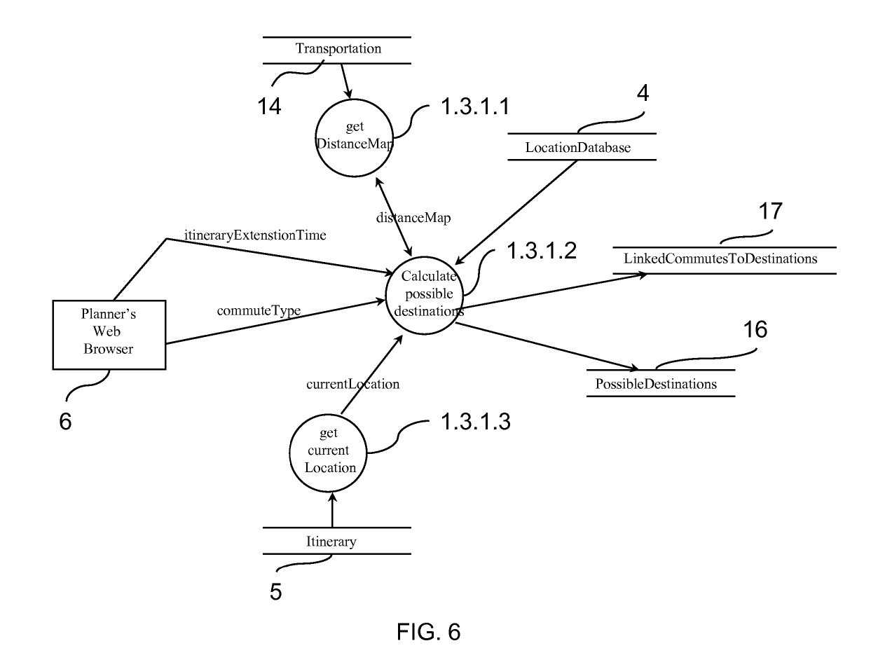

FIG. 6 shows an alternative way of determining possible destinations when the planner has opted to choose a single mode of transportation for the commute (see block 1.3.1 of FIG. 5). A distance map is provided for each unique form of transportation (block 1.3.1.1). For example, a car would necessitate a distance map based on street layouts, while transportation by foot would necessitate provision of walking distances based on sidewalk and walking paths. A unique commute time is then calculated (block 1.3.1.2) for the distance between the current location of the Itinerary (retrieved in block 1.3.1.3. Also, see block 1.2.3 of FIG. 4.) and all locations in the territory. If the calculated commute time is less than the itinerary extension time, it is deemed to be reachable in the allotted time and added to possible destinations. The associated commute activity is added the LinkedCommutesToDestinations.

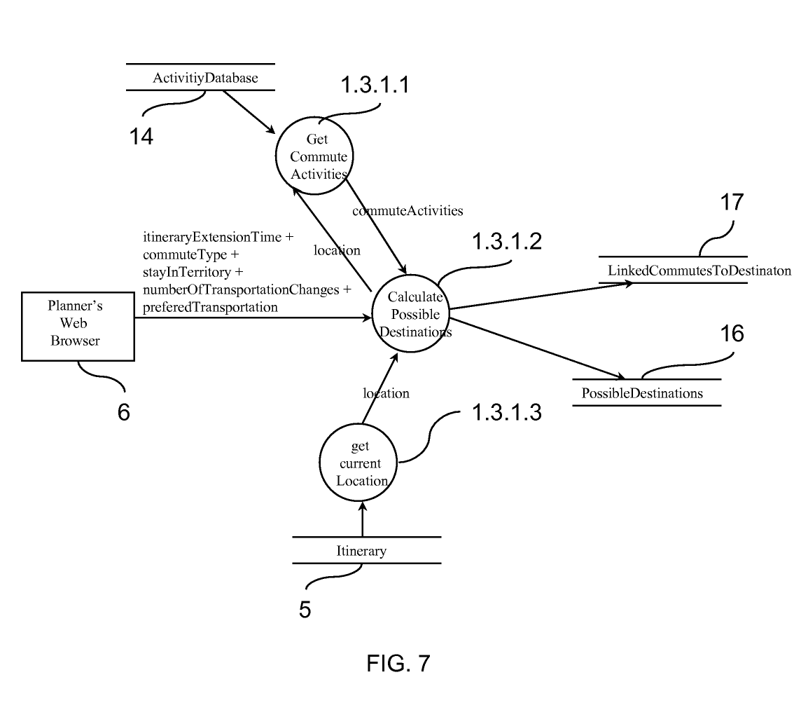

FIG. 7 shows an alternative way of determining possible destinations when the planner has opted to allow the itinerary planning tool to calculate multiple transportation changes in the same continuous commute. Given a location, the ActivityDatabase 2 is queried for activities that are commuting related (block 1.3.2.1). Examples include, but are not limited too, hired car, taxi, limo service, scheduled bus service, scheduled airplane service, and scheduled train service. The duration of the commute activity is then added to a running total in order to determine possible destinations 16 (block 1.3.2.2). The destination of the commute is used once again to find commuting activities at the location retrieved in block 1.3.2.3, and the process is repeated until no commuting activities are found at the new destination. If the total cumulative commute time is less than the itinerary extension time, it is deemed to be reachable in the allotted time, and is added to the list of possible destinations 16, and consequently, the associated commute activities are added to the LinkedCommutesToDestinations 17.

The users appreciate that the multiple transportation mode option provides the flexibility to change and pick different modes of transportation in a single commute. This allows activities that were impossible to reach with a single mode of transportation. Previous “route planning” tools assumed the car as a total transportation solution. The itinerary planning tool of the invention allows for changing from a rental car to a plane, train, bus, or the like, to allow visiting multiple territories in the same itinerary.

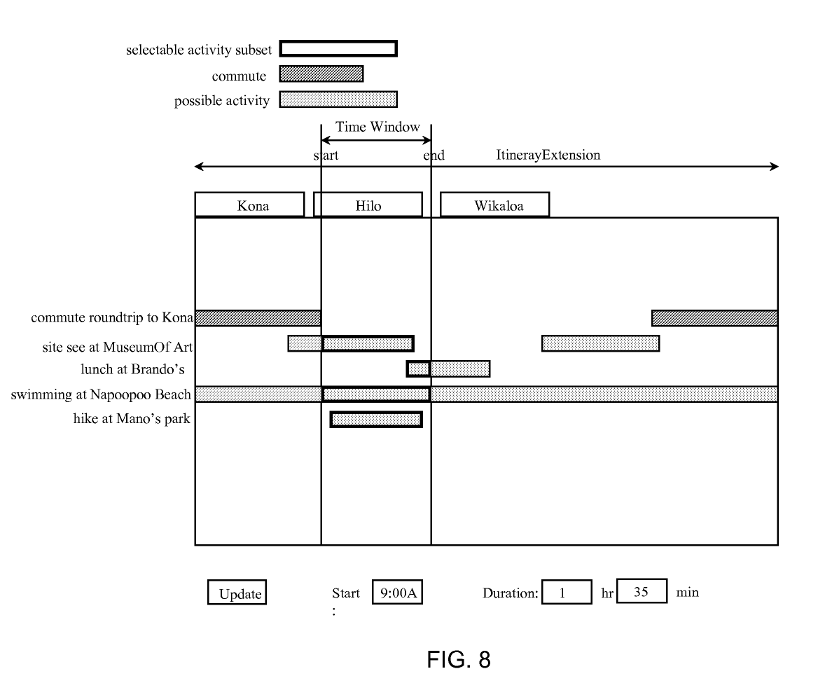

FIG. 8 is a schematic screen shot of a user friendly interface for allowing the planner to select a single subset of an activity from potentially dozens. The Planner provides input of the start time and the duration he wants to spend on the activity, and then draws a time window. The provided time window is displayed by two lines intersecting all possible activity time lines at a given location. The possible activities have now been narrowed down to some selectable absolute activities. In one embodiment, the itinerary planning tool only responds to selections that are located in the time window. The selectable activities are represented by the outlined subsets of the activities.

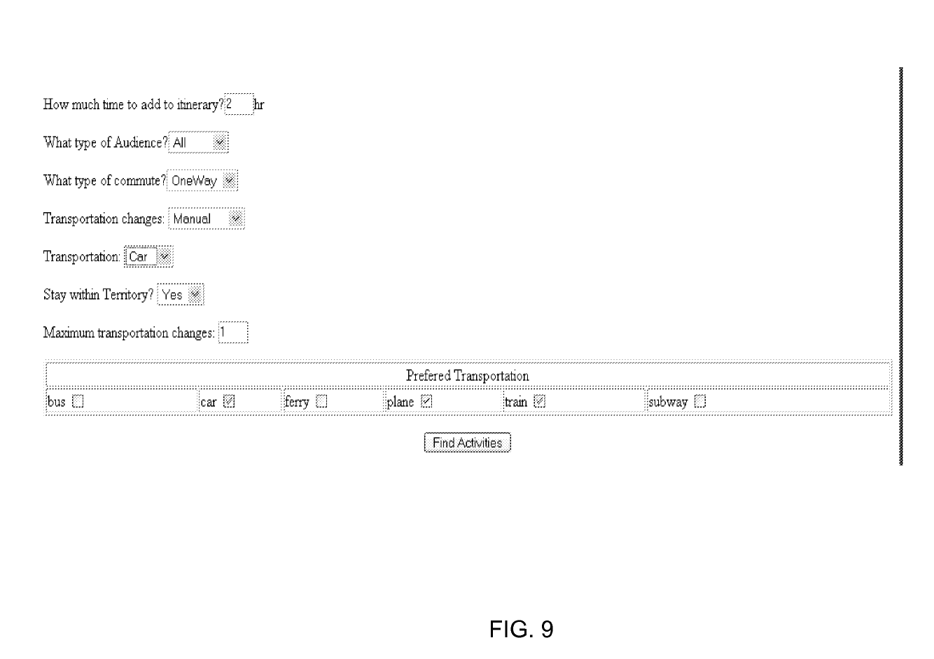

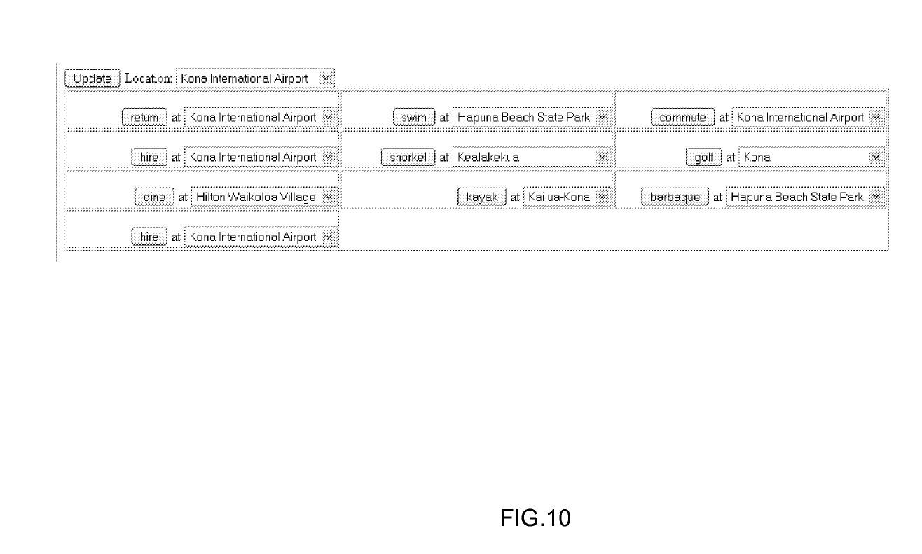

FIG. 9 depicts the input screen for adding an activity, including blocks for selecting transportation modes, while FIG. 10 depicts an alternative example of an input screen for inputting selected activities.

According to an embodiment of the invention, the user or planner selects the amount of time to append to the itinerary, properties of the activity, and process for selecting transportation. If the manual selection option is chosen, the planner picks a single mode of transportation from an inventory he has previously acquired. If he has rented an automobile, the planner may switch from default foot transportation to car. If computer-assisted selection is chosen, the planner selects whether to venture out of current territory, the number of transportation changes, and preferred types of transportation. The itinerary planning tool will then find transportation hubs and change to new transportation types, as necessary for the commute.

Once the itinerary is chosen, the itinerary planning tool will calculate how far the planner can commute in the allotted itinerary extension. From the set of reachable locations, all possible activities are retrieved from database that occur at each location. Previous systems required knowledge of activity types in the foreign territory. The current system sorts activities by type and presents to Planner for selection, as FIG. 10 shows. The Planner selects the activity's location, since same activity may happen at several locations.

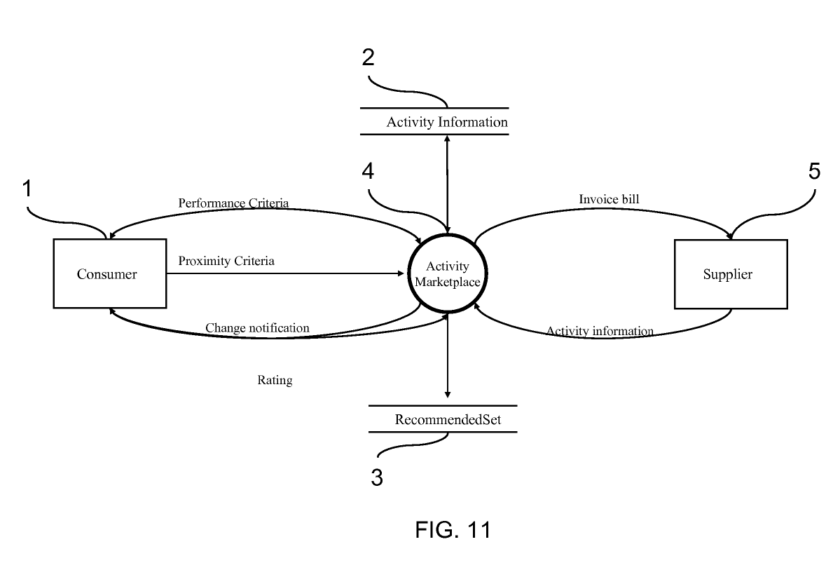

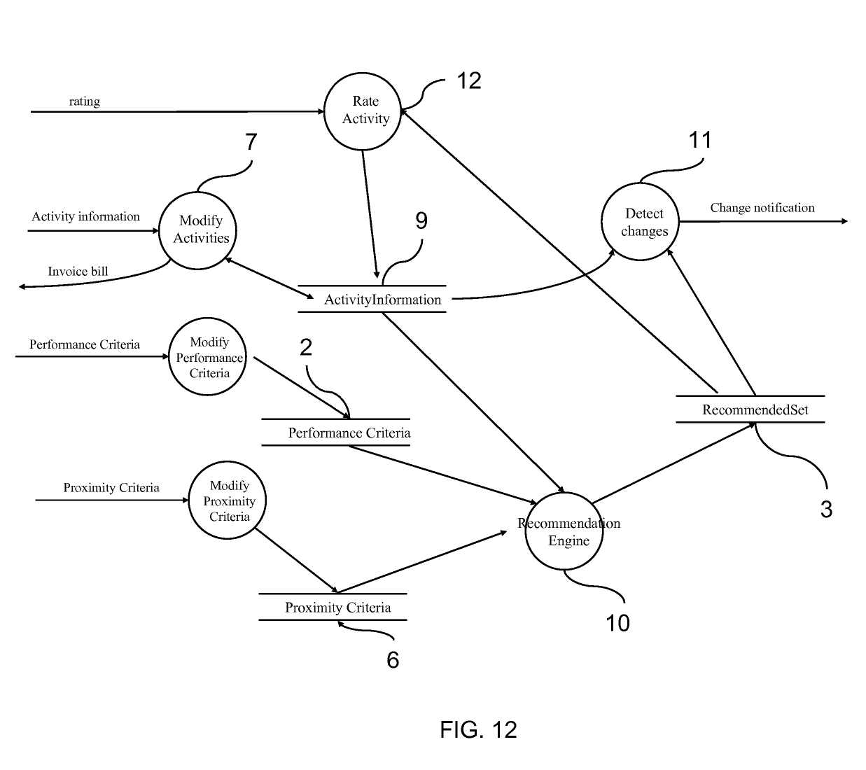

Now referring to FIGS. 11 and 12, an embodiment of the activity marketplace 4 would be a web-based software application of an electronic marketplace.

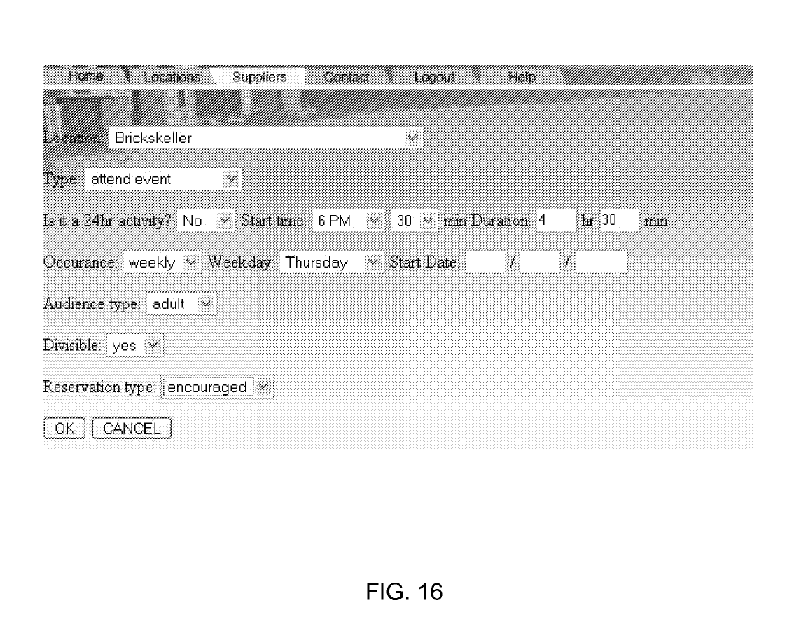

Supplier Side: To populate the activities database 2, the supplier 5 would use a web page data entry form, to enter activity information, as illustrated in FIG. 16. The activities database would reside on the web server side of the system. This system would charge a supplier 5 for entering the activity in the activity marketplace. Since it is self-sufficient, the web server would send electronic billing to the supplier 5, for example, with choices of email, or displaying said billing on a web page, to be printed out.

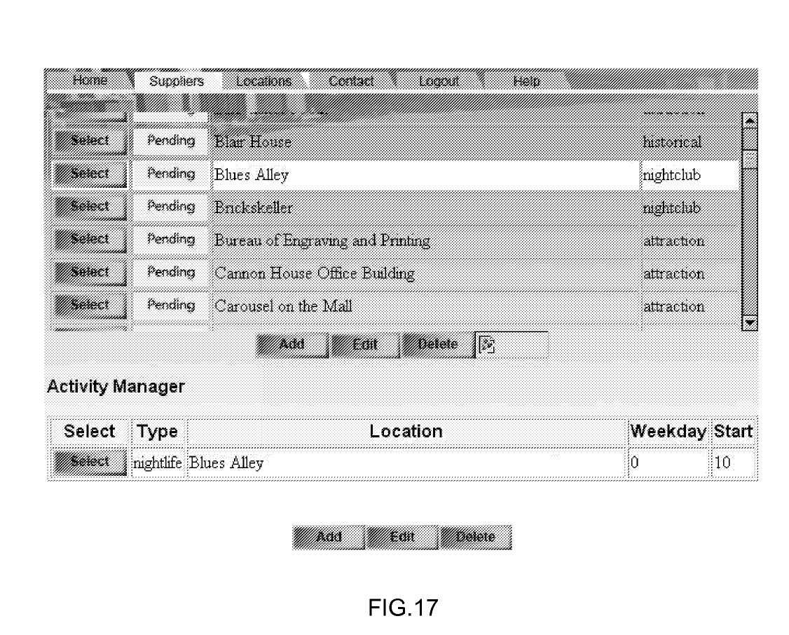

For managing and tracking existing activities in the database, the supplier would use the Activity Manager page, as illustrated in FIG. 17.

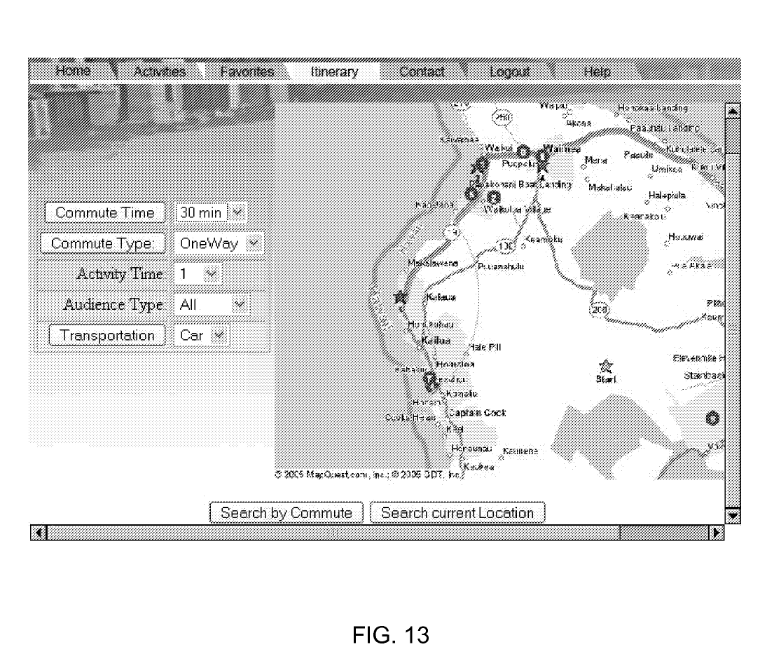

Consumer Side: The consumer 1 interacts with the application controls on the client side of the system. A web page data entry form as illustrated by FIG. 13 would have means to enter proximity criteria 6, such as address, mode of transportation, amount of commuting time available, and time window of start and end dates, to granularity of a minute. A web page data entry form would have means to enter performance criteria 7, such as age, physical fitness level, and group or individual preferences.

With criteria entered, recommendation engine 10, on the server side, would carry out the searching activities. The recommendation engine 10 would consider performance criteria 2 and proximity criteria 6, to filter out irrelevant activities from the activity database 9 search. This narrowed set of activities would be the recommended set 3 given to the consumer, as the best possible activities for them to attend. The recommended set 3 could be emailed upon completion or immediately viewed, given the speed of execution of today's computer technology. Since the activities are changing dynamically, the consumer 1 will be notified, if their recommendation set 3 of activities has been changed.

Detected changes means 11 monitors changes in the activities database 2 for changes that will invalidate the original recommendations. Notifications of changed activities are then sent by email, or viewed the next time the consumer 1 visits the system.

Consumers that have attended the activity are given means to rate their satisfaction. The Rate activity 12 function will check to see that Consumer has actually attended the activity, to give their rating credibility.

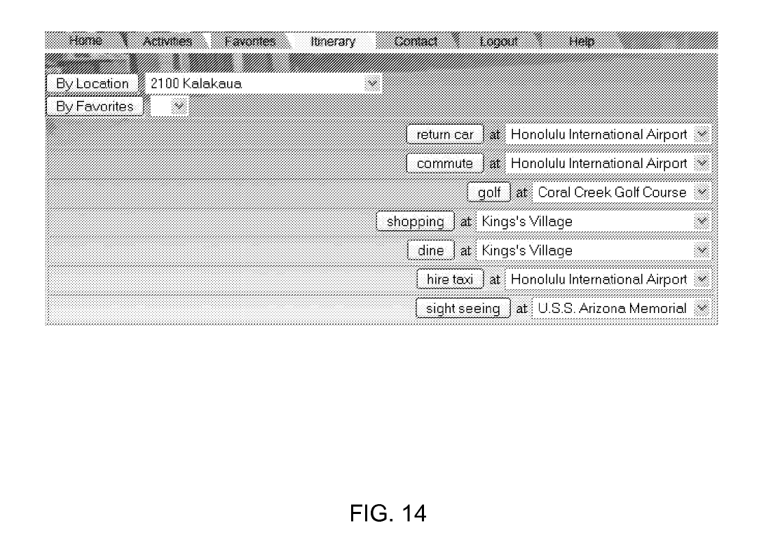

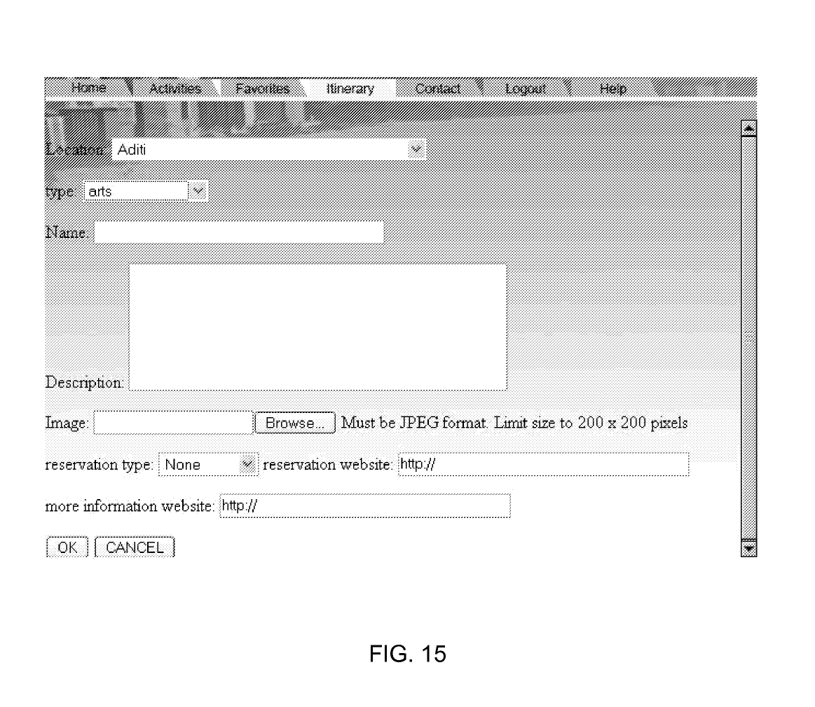

FIGS. 14-15 are also 2 other snapshots of the screen for user interface, to show activities and related information.

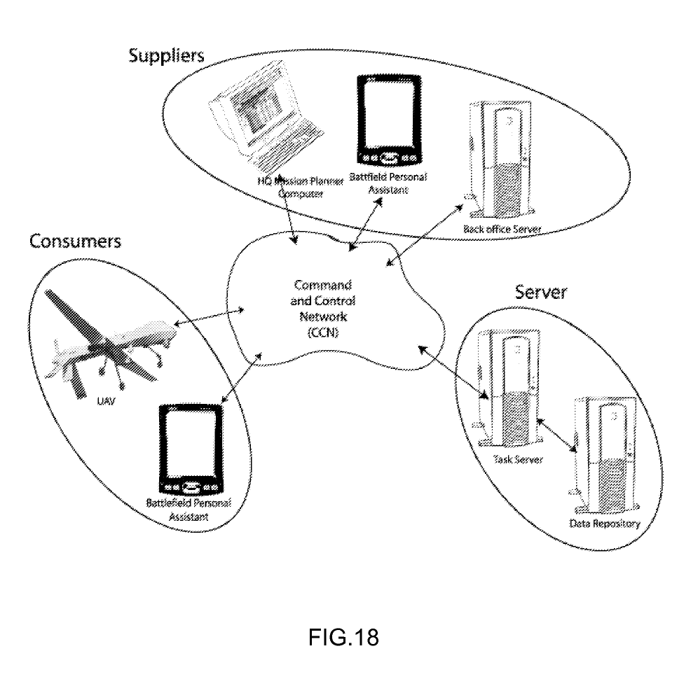

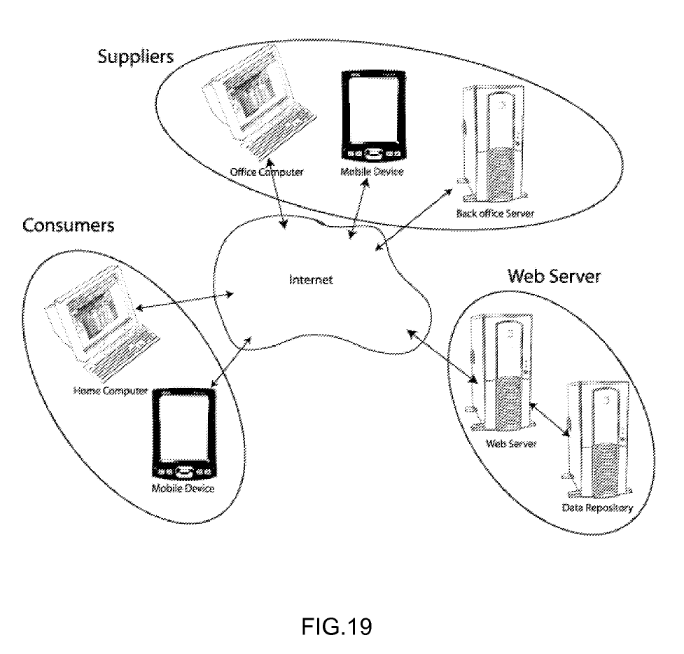

The invention can be applied to the distribution of goods, such as for a chain store, for example, in Wal-Mart. This can be applied to the consumers proactively looking to see what things are within their reach or selection (in consumer market) (for example, see FIG. 19). It also can apply to the military procurement/government subcontracting (FIG. 18, for example). This can be used in a plumbing business with multiple trucks and plumbers, covering a large part of the town, with many emergency calls waiting for repairs, to optimize the drivers' routes to the nearest customers, and speed up the process (saving money/increase customer satisfaction, for the plumbing or any business/organization with a dispatch, or dealing with the distribution of resources, man power, expertise, services, objects, or merchandise).

### EXAMPLE

### Embodiment of Task Management for Military Vehicle Assets

Problem: As a task manager, one has several tasks to be performed by assets. The manager is not concerned with which asset performs a task, but rather is concerned that all tasks are completed. The number of assets under the manager's authority is overwhelmingly large. It has the added complication that the variety and ability of the assets to perform a task change quickly overtime. It is not possible to query each asset, analyze its ability to perform the task, and search for the most appropriate tasks.

Solution: To overcome task management challenges, the invention gives assets authority to choose their most appropriate task. Assignments are no longer pushed from the task manager onto an asset. The asset is the best judge as to whether it can carry out a task. The asset searches a task repository, signifies the ones it will perform, and modifies the task repository on results of carrying out the task.

Embodiment: Now, referring to the figures, an embodiment of the activity marketplace 4 would be a message-oriented approach to an electronic marketplace system 22. Of the many task management applications, a military combat task management will be presented.

Supplier Side: On a mission planner computer at Headquarters, the manager would create a multitude of tasks. The tasks would encompass all types for assets under the headquarters' control. Assets would include, but not limited to, Unmanned Ariel Vehicles (UAVs), armored vehicles, satellites, re-supply trucks, and combat units. These tasks would be translated into electronic messages, to be sent across the Command and Control Network (CCN), to be stored in the Task Server (see FIG. 18).

User/Client/Consumer Side: An Asset, free to carry out a task, would search the Task Server for current tasks. A vehicle would use its current state as a basis for Performance criteria, including, but not limited to, remaining consumables, such as fuel and munitions, damage model, and mission type. It would use its current proximity data as basis for Proximity Criteria. The Performance Criteria and Proximity Criteria would be translated into electronic messages to be sent across the CCN to the task server.

With criteria input, the recommendation engine 10 on the server side carries out the searching tasks. The recommendation engine 10 considers performance criteria 2 and proximity criteria 6 to filter out irrelevant tasks from the activity database 9 search. This narrowed set of tasks is the recommended set 3 given to the asset/user as the best possible task/activities for them to perform, as illustrated by FIG. 14. The recommend set would be sent to the vehicle, via an electronic message. The message would be entered directly into the brains of an unmanned vehicle, or displayed for communication to vehicle commander.

With task complete, the asset/user would change its role to a supplier.

A human asset/user/consumer would enter results of carrying out the task on a mobile Battlefield Personal Assistant. An autonomous vehicular asset/user/consumer would enter its results in an electronic message. The results would travel across the CCN to the task Server. The task server would update the status of the task in the data repository.

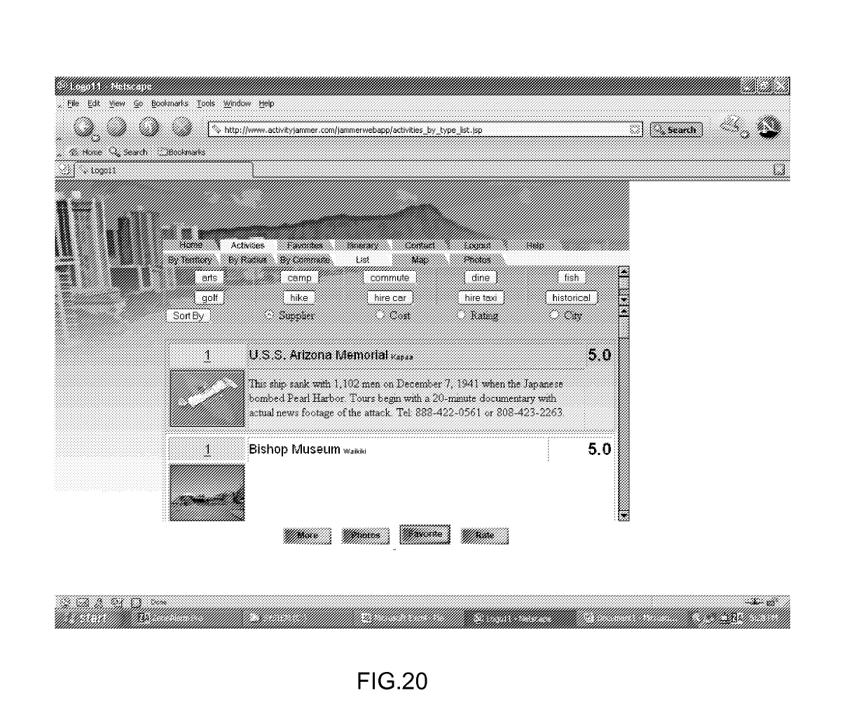

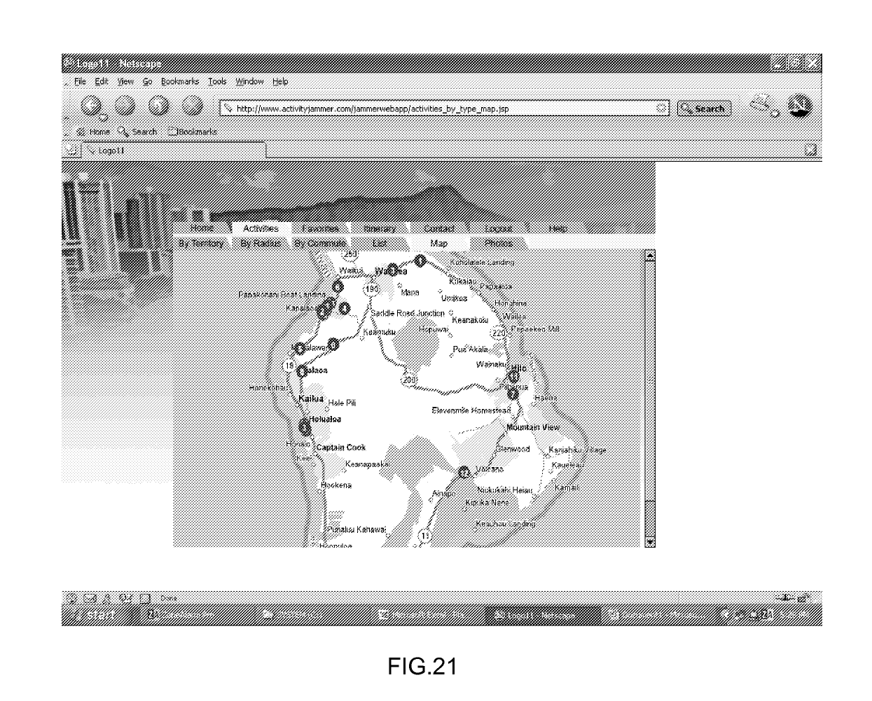

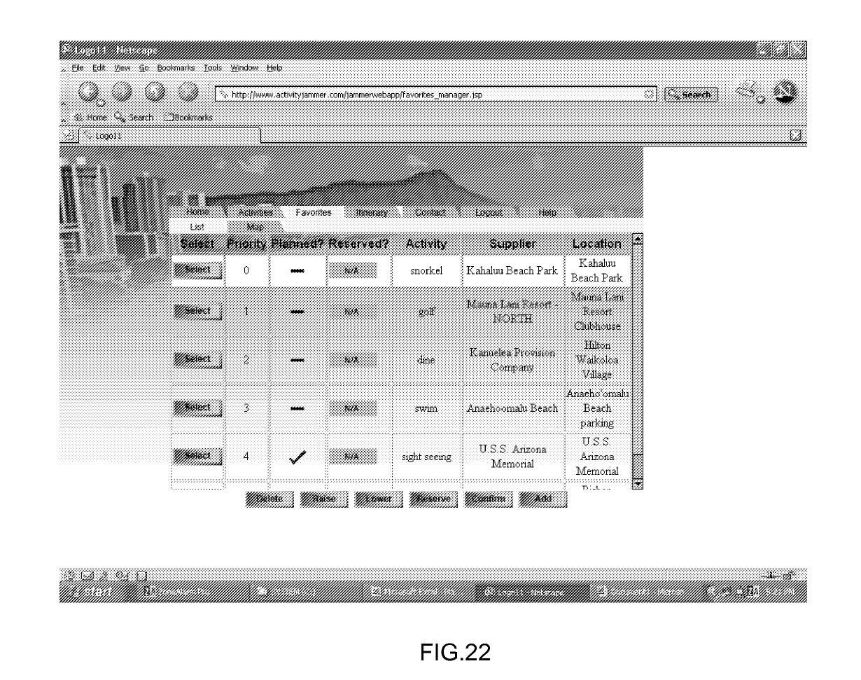

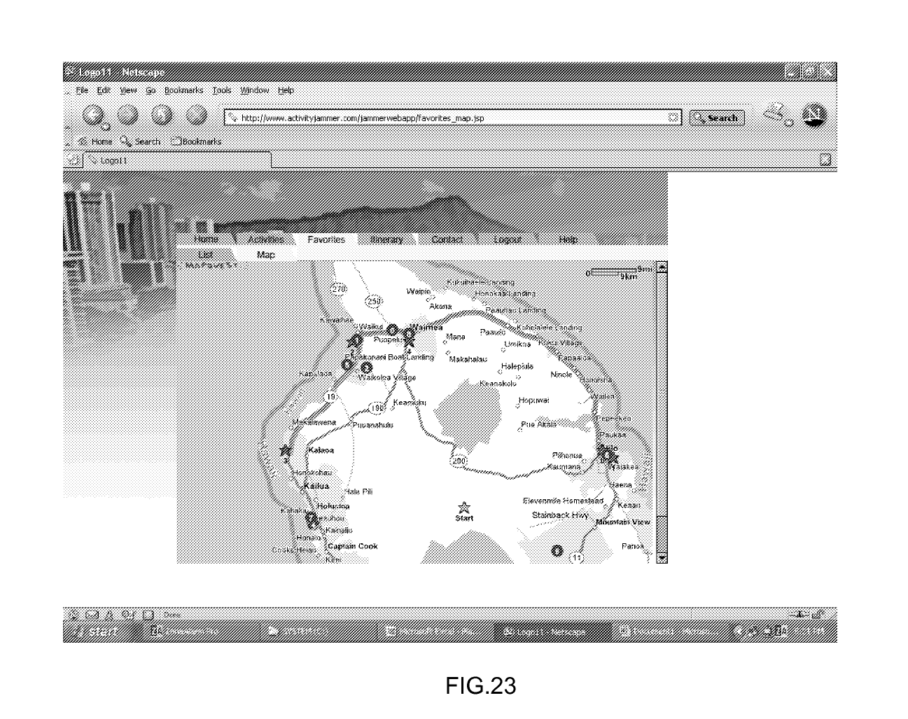

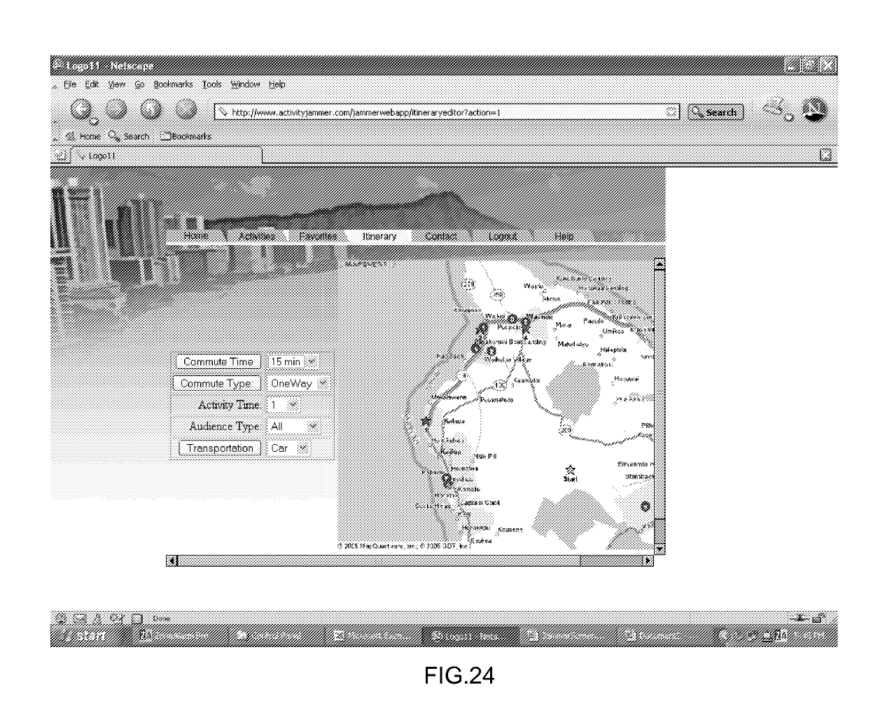

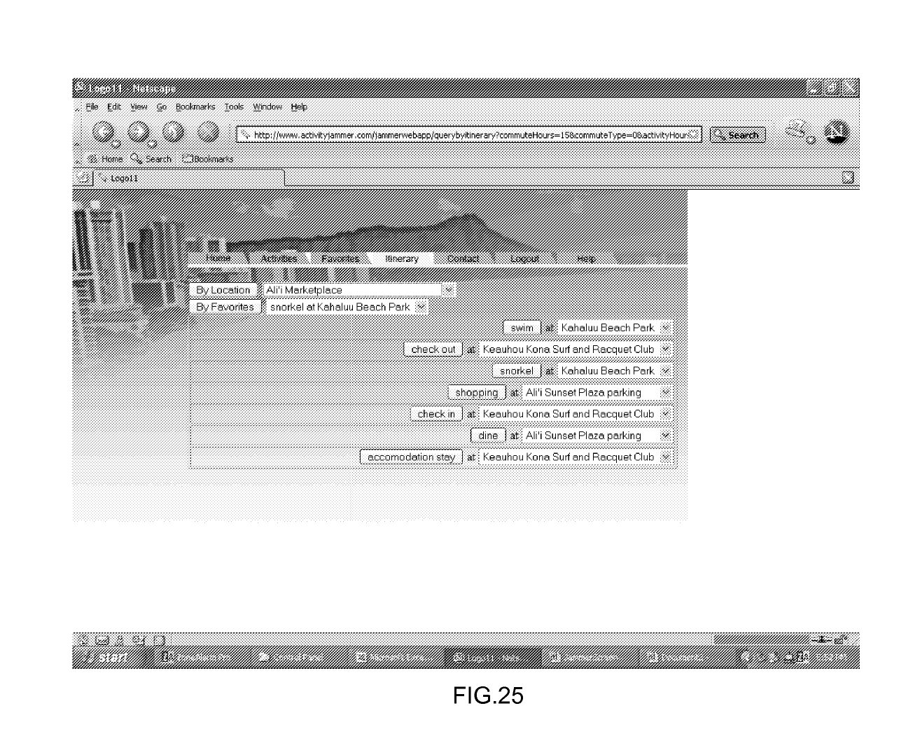

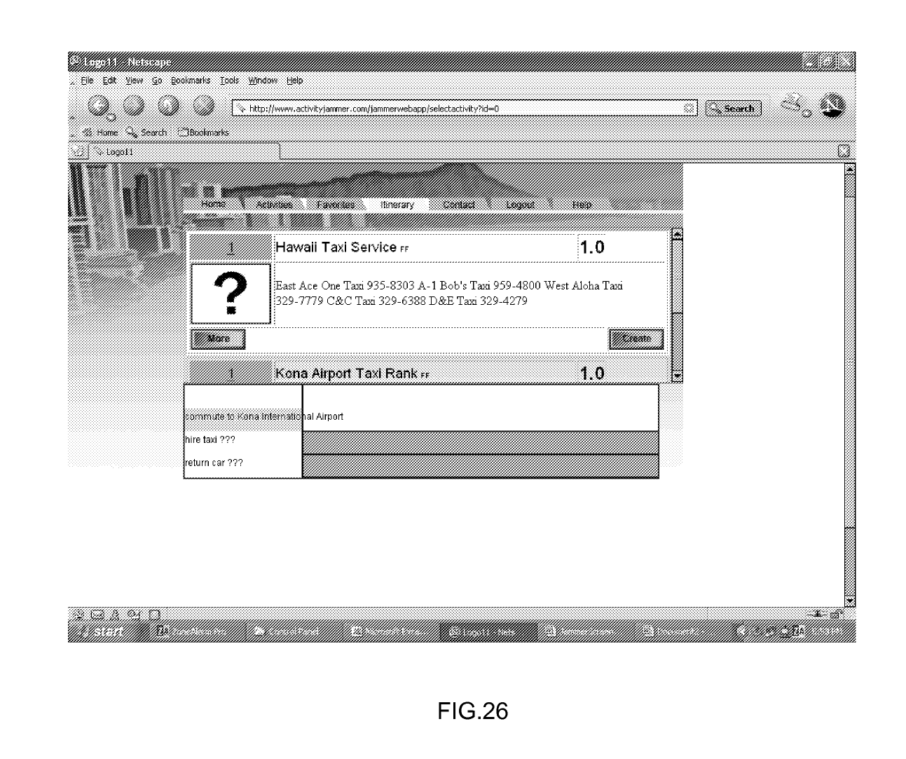

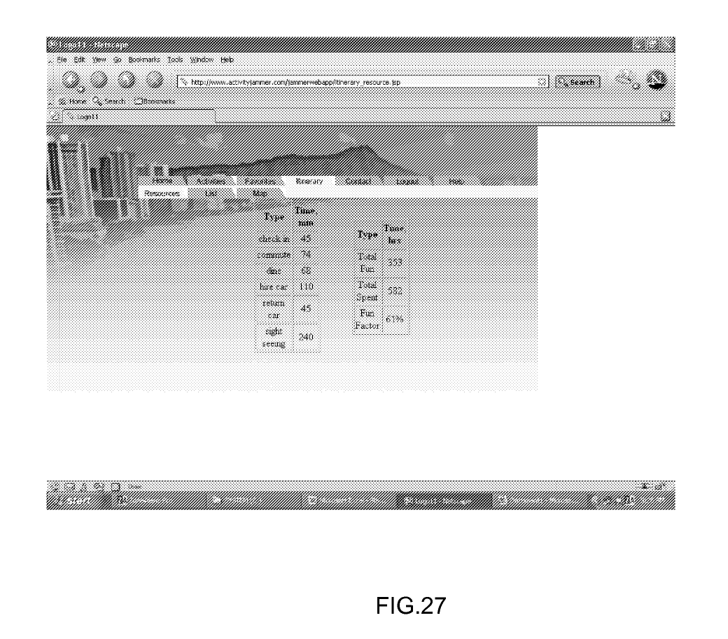

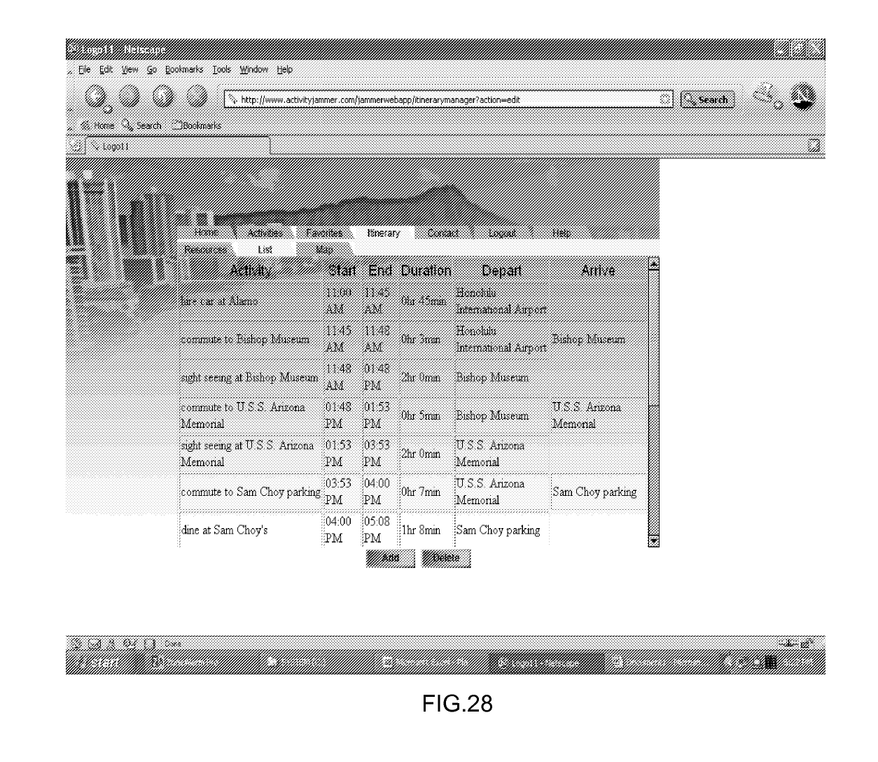

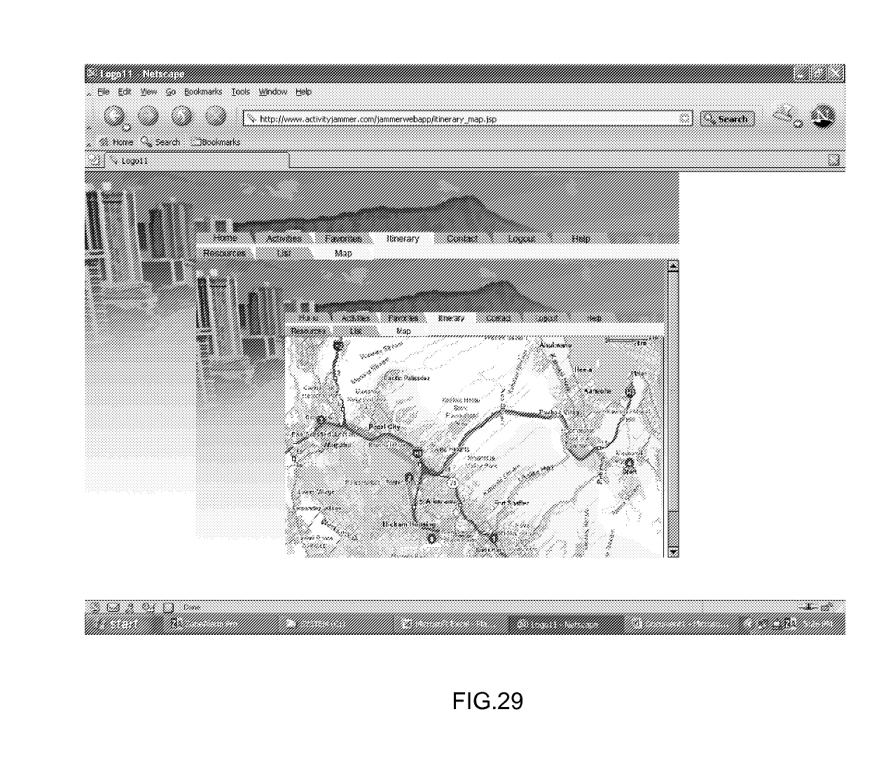

FIGS. 20-29 are snapshots of actual screen/interface for the user for a typical system, as explained below. For example, it describes the activities with the pictures and descriptions, shows the map and all relevant locations/proximities, with the selected activities/priorities/planned ones/reserved ones/supplier/location, color-coded for ease of use, with the range of access (to activities), specifying commuter type, commuter time, activity time, audience type, and transportation means, with favorites, locations, and itinerary.

The audience type can be for kids, family, adult-only, all, teenagers, based on life-style, disabilities (e.g. for blind people, deaf people, people wearing glasses, or people on the wheel chair), or body condition/shape (e.g. heart problem, kidney problem, or knee problem).

It also summarizes the results, such as Total Fun, for total vacation time, or Total Commute time in the bus, for overhead/wasted time, if the bus was not considered a tour/fun/entertainment vehicle, for example. Having the ratio of total fun time to the total time is an indication of how much the trip is fun for that user, making it a quantitative value for comparison with other scenarios and alternatives for that user, for the purpose of maximizing fun or optimizing the vacation.

Parts of the system: The module PlanIt has a shopping cart feature, trip planner, and routing tool. It can be branded in accordance with the brand of the subscriber web site, for example. Activity management and mapping can be customized. The module WhatsClose features search, map, route, and manage functions, to optimize the vacation for a tourist or the business trip for a businessman.

The followings are unique in the current system: validation feature, plus filtering feature through millions of combinations/choices, rating system, favorite list, prioritization, list view, map view, using different symbols, preference list, with bar diagrams representing parallel events in time, color-coded, easy to see in one page, representing in a chain fashion, in a hierarchical fashion, with local time, local holidays, flight delays, reservation chart/table, and corresponding maps with markings.

Any user can add activities (such as for dining in a restaurant, with reservation) and change them. The restaurants can be listed, and then get authenticated or certified by the system, users, independent critics, local organizations, or a third party, for a fee, free, on a subscription, or based on the agreement for giving discounts to the users in the future.

The system comprises a calendar for specifying the dates, windows of dates, or any dates that are off-limits, such as Federal holidays, when a museum might be closed.

This invention can be applied to auction or exchange situations, as well, with supplier and consumer auctioning, offering, or exchanging any items, including services, tangible products, information, future ownership, or rights to an intellectual property.

In addition, any variation of all of the above teaching is also intended to be covered by this patent application. All of the teachings above, including the figures, are just for the purpose of example, and they do not limit the scope of the invention.

1. A system for one or more consumers and one or more suppliers of one or more activities, tasks, services, merchandises, products, entertainment items, professional offerings, or information, to meet, exchange, offer, purchase, sell, auction, or receive, said system comprising:
an activity marketplace;
a first interfacing module for interfacing said one or more consumers to said activity marketplace; and
a second interfacing module for interfacing said one or more suppliers to said activity marketplace,
wherein said system operates based on performance criteria and/or proximity criteria.

2. A system as recited in claim 1, wherein said system retrieves, stores, updates, changes, or sets activity information.

3. A system as recited in claim 1, wherein said system interfaces a computer.

4. A system as recited in claim 1, wherein said system interfaces the Internet or a web browser.

5. A system as recited in claim 1, wherein said system interfaces a computer network.

6. A system as recited in claim 1, wherein said system notifies said one or more suppliers or said one or more consumers about the changes.

7. A system as recited in claim 1, wherein said system has a rating section.

8. A system as recited in claim 1, wherein said system recommends a set of activities.

9. A system as recited in claim 1, wherein said system has a billing section.

10. A system as recited in claim 1, wherein said system supplies or stores detailed information about activities.

11. A system as recited in claim 1, wherein said system updates the recommendation based on the changes.

12. A system as recited in claim 1, wherein said system shows a map.

13. A system as recited in claim 1, wherein said system offers different choices of transportation.

14. A system as recited in claim 1, wherein said system calculates or estimates the commute time.

15. A system as recited in claim 1, wherein said system uses color-coded displays, windows, charts, graphs, pictures, maps, or drawings.

16. A system as recited in claim 1, wherein said system supplies or stores information about facilities, points-of-interest, or locations.

17. A system as recited in claim 1, wherein said system comprises a calendar.

18. A system as recited in claim 1, wherein said system specifies, stores, or changes the audience type.

19. A system as recited in claim 1, wherein said system comprises information about divisible activities.

20. A system as recited in claim 1, wherein said system comprises information about indivisible activities.

21. A system as recited in claim 1, wherein said system comprises or interfaces with reservation information.

22. A system as recited in claim 1, wherein said system is used for military or government activities.

23. A system as recited in claim 1, wherein said system is used for dispatching activities.

24. A system as recited in claim 1, wherein said system comprises a feedback section.

25. A system as recited in claim 1, wherein said system is used for vacation activities.

26. A system as recited in claim 1, wherein said system comprises a priority list.

27. A system as recited in claim 1, wherein said system prevents the choice of activities that are impossible to achieve, based on one or more of the followings: distance, time, health, age, disability, commute time, vehicle condition, modes of transportation, labor strikes, preference, religion, law, local holiday, weather, and traffic.

28. A system as recited in claim 1, wherein said system computes one or more of the followings: total fun time, business time, vacation time, cruise time, train time, overhead time, wasted time, and commute time.

29. A system as recited in claim 1, wherein said system computes the ratio of two or more of the followings: total fun time, business time, vacation time, cruise time, train time, overhead time, wasted time, and commute time.

30. A system as recited in claim 1, wherein said system computes the percentage of one or more of the followings: total fun time, business time, vacation time, cruise time, train time, overhead time, wasted time, and commute time.

31. A system as recited in claim 1, wherein said system indicates one or more of the followings: routes, points-of-interest, arrival time, departure time, and duration.

32. A system as recited in claim 1, wherein said system is used for the distribution of a merchandise.

33. A system as recited in claim 1, wherein said system is used for optimization of tasks or activities.

34. A system as recited in claim 1, wherein said system is used based on fee, free, subscription, ad, reciprocity, contract, coupon, or future discount.

35. A system as recited in claim 1, wherein said system is used to build an itinerary.
